(19) United States
(12) Patent Application Publication
(10) Pub. No.: US 2026/0109888 A1
(43) Pub. Date: Apr. 23, 2026

(54) Adhesives Adapted For Spray Applications

(71) Applicant: Zephyros, Inc., Romeo, MI (US)

(72) Inventors: Hamid Mortazavian, Romeo, MI (US); Michael Czaplicki, Romeo, MI (US); Dietmar Golombowski, Romeo, MI (US); Donald Paquet, Romeo, MI (US); Laura Sivec, Romeo, MI (US)

(21) Appl. No.: 18/854,143

(22) PCT Filed: Apr. 28, 2023
(86) PCT No.: PCT/US2023/020426

§ 371 Date: Oct. 4, 2024

Related U.S. Application Data
(60) Provisional application No. 63/336,405, filed on Apr. 29, 2022.

(51) Int. Cl. C09J 163/08; C09J 4/00; C09J 11/04; C09J 11/06; C09J 163/04

(52) U.S. Cl. CPC C09J 163/08; C09J 4/00; C09J 11/04; C09J 11/06; C09J 163/04

(57) ABSTRACT

A two-part system comprising a first component including one or more epoxy resins and an epoxy functional material, the epoxy functional material having a functionality of greater than 4 and a viscosity of 500 cps or less according to ASTM D2556-14 at 23°; and a second component including one or more phosphate esters and having a viscosity during deposition of 500 cps or less according to ASTM D2556-14 at 23°.

### FIELD

The present teachings relate generally to an ambient temperature-activated thermosetting composition comprising a first component including an epoxide functional constituent and optionally a blowing agent decomposition initiator in the case of foamable compositions, and a second component including an acidic constituent that functions as a curing agent.

### BACKGROUND

Sprayable formulations for adhesion and/or sealing are useful for their simplified deposition capability. However, materials having sufficiently low viscosity for spray applications are often lacking in physical characteristics or present manufacture challenges.

It may be desirable for sprayable materials to have a viscosity of 500 cPs as measured according to ASTM D2556-14. This limits the presence or percentages of certain resins and curatives in the formulation. High to very high molecular weight polymers, or resins with high viscosities will be limited in the percentage permissible. Controlling the reactivity, thixotropic properties, and maintaining an accurate ratio of resin to curative are some of the challenges for these sprayable thermosetting compositions.

A drawback of spraying a very low viscosity material is the possibility of material flowing freely on the substrate. Adjusting the ratio of difunctional to multifunctional material in both the resin and curative sides may assist in controlling reactivity and provide rapid crosslinking that initiates creation of a 3-dimensional structure of the material.

To achieve the viscosity requirement for impingement mixing (typically 500 cPs for the liquid portion), the liquid ingredients for the material should be low viscosity at the deposition temperature, preferably highly shear thinning, or both. High to very high molecular weight polymers could have concentration limits. Also, the concentration of very high viscosity liquids or semi solids could be limited. Limiting ingredient selection to smaller molecules and monomers in a formulation can create difficulties.

PCT Publication Nos. WO 2020/101732, WO 2020/205355, WO 2020/206346, and WO 2020/198139 illustrate the use of phosphoric acid and phosphate esters for cure-in-place compositions. These compositions are typically employed for a wide range of room-temperature activated systems, such as rigid structural foams, cavity filling, gaskets, and sealants. The benefits of such compositions may include the ability to adhere to a variety of substrates, the inclusion of low volatility organic compounds (VOC's), not being sensitive to the dispensing temperature, not being sensitive to the exact mixing ratio of a two-part system, the ability to tune physical and mechanical properties, or any combination thereof.

The present teachings solve one or more of the problems addressed above by providing two-component compositions that maintain sufficiently low viscosity to be adapted to spray applications while rapidly crosslinking to avoid flow and maintaining desirable physical properties.

### SUMMARY

The present teachings provide for a two-part system comprising a first component including one or more epoxy resins and an epoxy functional material, the epoxy functional material having an epoxy functionality of greater than 4 and a viscosity of 500 cps or less according to ASTM D2556-14 at 23°; and a second component including one or more phosphate esters, the one or more phosphate esters having a viscosity during deposition of 500 cps or less according to ASTM D2556-14 at 23°.

The teachings herein are further directed to a two-part system (two-component system) comprising: a first component comprising one or more epoxy resin and an epoxy functional compound having an epoxy functionality of greater than 4 and a viscosity of 500 mPa·s or less in its neat state; and a second component comprising one or more phosphate esters each having a viscosity of 500 mPa·s or less in its neat state. In each case viscosity is determined as described herein.

The teachings herein are also directed to a two-part system (two-component system) comprising a first component essentially consisting of one or more epoxy resins, an epoxy functional compound having an epoxy functionality of greater than 4, and optionally, one or more non-liquid constituents. The one or more epoxy resins and the epoxy functional compound have an overall viscosity of 500 mPa·s (in admixture with one another but in the absence of the one or more non-liquid constituents). The system includes a second component essentially consisting of one or more phosphate esters and optionally, one or more non-liquid constituents. The one or more phosphate esters have an overall viscosity of 500 mPa·s or less (in admixture with one another but in the absence of the one or more non-liquid constituents). In each case viscosity is determined as described herein.

Upon mixing the first component and second component, the resulting composition may cure at a temperature of about 0° C. to about 50° C.

The first component may include an epoxidized di-aniline. The one or more phosphate esters may include a phosphate ester derived from cashew nutshell liquid (CNSL). The one or more phosphate esters may include a phosphate ester derived from 2-ethylhexyl glycidyl ether. The one or more phosphate esters may include a phosphate ester derived from phenyl glycidyl ether. The one or more phosphate esters may include a phosphate ester derived from an epoxidized para-tertiary butyl phenol.

The two-part system may include one or more additives selected from a core-shell polymer, calcium carbonate, minerals, reinforcing fiber, hydrophobic silica, a monomer, tabular alumina, or any combination thereof. Calcium carbonate may be present in an amount from about 0.01% to about 10% by weight, relative to the total weight of the two-part system. An ultrafine calcium carbonate (about 1 micron average particle size), a fine calcium carbonate (about 4 micron average particle size), a medium fine calcium carbonate (about 22 micron average particle size), or any combination thereof may be included in the two-part system.

One or both of the first and second component may include Wollastonite. One or both of the first and second component may include fumed silica.

The one or more epoxy resins or epoxy functional material may include one or more liquid epoxy resins, one or more epoxy phenol novolac resins, one or more aliphatic multifunctional epoxy resins, one or more phenoxy resins, one or more silane modified epoxy resins, or any combination thereof.

The two-part system may include one or more epoxy phenol novolac resins with an epoxy functionality from about 2 to about 3; an epoxy phenol novolac resin with an epoxy functionality from about 3 to about 4; or both. The two-part system may include one or more epoxy phenol novolac resins present in an amount from about 15% to about 70% by weight, relative to the total weight of first component.

The two-part system may be substantially free of curing agents, latent curing accelerators, or both, other than the one or more phosphate esters.

The first component, the second component, or both may include a dicarboxylic acid-based constituent. The first component is substantially free of any epoxy resins that in their neat state are solid at temperatures of 20° C. to 25° C. The second component may be substantially free of any epoxy resins that in their neat state are solid at temperatures of 20° C. to 25° C.

The first component and second component may be present in a ratio of from about 5 parts by volume first component:1 part by volume second component to about 1 part by volume first component:1 part by volume second component.

The second component may include less than 5% by weight epoxy resins that in their neat state are solid at temperatures of 20° C.-25° C., relative to the total weight of the second component.

In each case viscosity is measured at a shear rate of 0.004 (1/sec) for 120 seconds, the rate is then logarithmically ramped from 0.004 to 400 (1/sec) over the course of 120 seconds and held at 400 (1/sec) for an additional 120 seconds; wherein test concludes by immediately reducing the shear rate from 400 to 0.004 (1/sec) and subsequently measuring the viscosity recovery over the next 480 seconds.

The two-part system may include one or more epoxy phenol novolac resins present in an amount of at least 40% by weight, preferably at least 50% by weight relative to the total weight of first component.

The two-part system may include one or more aliphatic multifunctional epoxy resins in an amount of at least 10% by weight relative to the total weight of the first component.

### BRIEF DESCRIPTION OF THE DRAWINGS

FIG. 1 shows how the viscosity of Kane Ace MX-267 changes at different temperatures and shear rates.

FIG. 2 shows the viscosity of liquid section of side-A (first component) and side-B (second component) of an example formulation.

FIGS. 3A and 3B compare viscosities of side-A (first component) and side-B (second component) of the two different formulations

FIG. 4 shows the viscosity of the B-side (second component) (including the non-liquid constituents) of formulation 248 at various RPM rates.

FIGS. 5A and 5B show the 3 Interval Thixotropy Testing results that shows viscosity at different shear rates and 2 different temperatures.

### DETAILED DESCRIPTION

The present teachings meet one or more of the above needs by the improved compositions and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

For the purpose of the specification, the terms “two-part system” and “two-component system” are used interchangeably. The same applies in this context to the individual terms “part”, “component” and “side”, e.g. “A-side”, “side-A”, “B-side” and “side-B”. Unless expressly stated otherwise, the “first component” corresponds to the “first part”, “side-A” and “A-side”, respectively. Unless expressly stated otherwise, the “second component” corresponds to the “second part”, “side-B” and “B-side”, respectively.

Described herein is a low viscosity two-component material which is adapted to be spray-applied, which could be dispensed and mixed using an impingement mixing application system. The present teachings relate to the application of a low viscosity two-component composition (both formulated sides (components) preferably having a viscosity of 500 cPs or less according to ASTM D2556-14 at 23°, where the two components collide at high velocity, to produce impingement mixing. It is also possible that the two components may be mixed in a static or dynamic mixer. Post mixing, the resulting formulation may then be sprayed onto a substrate, or into a mold or cavity.

The present teachings relate to a two-component room-temperature activated composition, comprising an epoxide functional system (side-A (first component)) cured using an acid or acidic derivative (side-B (second component)) with both formulated sides preferably having a viscosity of 500 cPs or less according to ASTM D2556-14 at 23°.

The current teachings demonstrate a system capable of impingement mixing comprised of an epoxide functional material or mixture, cured with an acid, acid derivative, or combination thereof. The impingement mixed material can subsequently be forced into a mold or cavity or dispensed onto a substrate.

The present teachings relate to a system adapted for spray application (air-assisted or airless). The mixed materials, after being impinged, are forced out through a spray nozzle prior to being applied onto a substrate.

The present teachings relate to two-component compositions that do not contain any volatile or flammable ingredients. Some critical ingredients in other two-component polymeric systems are either volatile or flammable at elevated temperature. Unlike many acrylate and polyurethane-based formulations and formulations containing solvents, the lack of volatile ingredients in the current two-component thermosetting compositions reduces the risk of inhaling toxic materials during any spray process.

The lack of any volatile and/or flammable ingredients may allow the user to increase the dispensing temperature if needed to adjust application viscosity or cure kinetics. Both side-A (first component) and side-B (second component) of the current two component composition are stable at elevated temperatures. Both side-A (first component) and side-B (second component) could be held at elevated temperatures, up to 80° C. or even higher, for an extended period of time without inducing decomposition or reactive instability.

It is possible that neither the side-A (first component) nor the side-B (second component) are sensitive to moisture, including at elevated temperatures. Sprayed material is typically low viscosity and is subdivided finely to produce a large volume of air exposure immediately after exiting the spray nozzle and before contacting the substrate.

The viscosity of the liquid portion of both formulated sides typically is 500 cPs or less. This limits the presence or percentages of certain resins and curatives in the formulation. High to very high molecular weight polymers, or resins with high viscosities will be limited in the percentage permissible. Controlling the reactivity, thixotropic properties, and maintaining an accurate ratio of resin to curative are some of the challenges for these sprayable thermosetting compositions.

One drawback of spraying a very low viscosity material is the possibility of material flowing freely on the substrate. Adjusting the ratio of difunctional to multifunctional material in both the resin and curative sides may assist in controlling reactivity and provide rapid crosslinking that initiates creation of a 3D structure of the material. Although using mono and difunctional resins is favorable to reduce viscosity, use of multifunctional materials in side-A (first component), side-B (second component), or both sides may also be desirable.

An important ingredient in the side-A (first component) of the sprayable thermosetting composition is a polymeric particle, which may be a core-shell material. As one example, Kane Ace MX-267 may be utilized which includes a dispersed core-shell additive in Bisphenol-F based epoxy. The polymeric particle dispersed in epoxy is a liquid impact modifier constituent that consists of a liquid and a solid. Although the viscosity of the core-shell is high, it is the liquid viscosity (viscosity of the bisphenol F resin), which is important for the spray application, with low viscosity preferred.

The present teachings relate to a two-component thermosetting composition which is not very sensitive to the mixing ratio. For example, if the target ratio of side-A (first component) to side-B (second component) is 4:1 (v/v), deviations up to 15% in the ratios do not impact the final properties significantly.

The compositions herein are preferably low viscosity compositions containing at least an epoxide functional constituent in the side-A (first component) and an acid or acidic derivative liquid having pH of less than 7 for the side-B (second component). Both the side-A (first component) and the side-B (second component) could be a formulated combination of multiple materials including liquid dissolved solids and particulate ingredients. Viscosity of both components typically are 500 cPs or less according to ASTM D2556-14 at 23°.

The final product is the result of mixing side-A (first component) (resin side) and side-B (second component) (curative side) and using mixing equipment, which may be an impingement mixer. Impingement mixing is one of the most effective methods of mixing, especially at low viscosities. Two component static and dynamic mixing equipment or cartridges or other types of mixing methods could be used to deposit these materials.

The current composition is a system capable of deposition and mixed using impingement mixing systems, comprised of an epoxide functional material or mixture (side-A (first component)) cured with an acid, acidic derivative, or mixture of them (side-B (second component)). In an impingement mixing system, side-A (first component) and side-B (second component) collide in a mixing chamber or mixing head at a very high velocity (under high pressure, in the range of 1200 to 3000 psi). The mixed material then can be pushed out into a spray nozzle or directly injected into a mold or cavity depending on the type of application.

Impingement mixing is a preferred type of mixing/dispensing machine for fast reacting materials such as polyurethanes and polyureas. The impingement mixing process is a very fast process, useful for large quantity deposition, fully automatic, and importantly, self-cleaning. In the process, two or more systems collide at high speeds, instantly randomize and mix, and leave the chamber immediately while the material is still in liquid form. After mixing and pushing the material out of the chamber, the plunger closes and empties the mix-head. This mixing method could be used for other two component systems, if the viscosity of the liquid portion of the mixture at the deposition temperature is below the threshold of the viscosity for the specific impingement mixing equipment (usually below 500 cPs); with a key element being the ability to produce a stream of fine liquid particles, often called an atomized stream.

To achieve the viscosity requirement for impingement mixing (typically 500 cPs for the liquid portion), the liquid ingredients for the material should be low viscosity at the deposition temperature, preferably highly shear thinning, or both. High to very high molecular weight polymers could have concentration limits. Also, the concentration of very high viscosity liquids or semi solids could be limited. Limiting ingredient selection to smaller molecules and monomers in a formulation can create difficulties. These difficulties and the methods to overcome them are explained in the current teachings.

Having a very low viscosity system containing many monomers and resins with low molecular weights usually means more reactive groups (functionality) per unit volume and greater molecular mobility particularly during the early stages of the reaction. The typical consequence of use of smaller molecules is faster cure and shorter open time combined with higher reaction exotherm. One potential drawback of a very fast cure material is limited handling time, or similarly, not having enough time to complete an assembly process. On the other hand, there could be limitations on the open time and fixture time depending on the process. Having longer handling time usually means longer fixture time which typically is not desirable. To overcome this problem, ingredients have been used in side-A (first component) and side-B (second component) of the current invention to control and balance the handling time and fixture time of the final product.

Adjusting the ratio of mono- and di-functional constituents to higher functionality multi-functional constituents in both resin and curative sides is useful in controlling the reactivity and providing early crosslinking that begins creating the 3-dimensional structure of the material (and stops the material from being free flowing) soon after being sprayed or dispensed. Although using mono- and di-functional resins are favorable to control the viscosity, using multifunctional materials in side-A (first component), side-B (second component), or both sides improve the properties of the cured composition. If the majority of one side or both sides of the sprayed material is mono-functional, then the cure time could be excessive or the material may not cure fully. Mono-functional resins and curatives cannot constitute the majority of side-A (first component) or side-B (second component) typically; however, they could be used to control the reactive kinetics and properties of final product. Maintaining a balance between mono- and di-functional to multi-functional resins and curatives is necessary to prevent the material form either flowing on the surface or curing too fast. To control this balance, the formulation may require higher viscosity materials (usually materials with higher reactive functionalities) which could create an additional difficulty. In the following sections, ingredients used to control the viscosity, as well as the effects of high shear rates and temperature on the spray-ability and final properties are explained.

The sprayable thermosetting composition described herein may contain a very low viscosity di-functional ingredient. Bisphenol-A epoxy resins may be utilized. DER 732 from Olin Company is one example. DER 732 is the product of epichlorohydrin and polypropylene glycol, with viscosity of 60 to 70 cPs at 25° C. Despite being a low viscosity material, it cures slowly. Epoxidized di-aniline resin such as Epotec YDM 441 is another ingredient which reacts slowly with phosphoric acid and phosphate esters which can impact handling time. Viscosity of this tetrafunctional epoxide is 3000 to 6000 cPs at 50° C. Viscosity decreases significantly at elevated temperature or high shear rates (shear thinning). A benefit of including the epoxidized di-aniline, despite having higher viscosity, is that the percentages necessary to impact the handling, fixture, and cure time of the formulation are very low (0.2 to 2% of the formulation). Chemical structures of DER 732 and Epotec YDM 441 respectively are shown below.

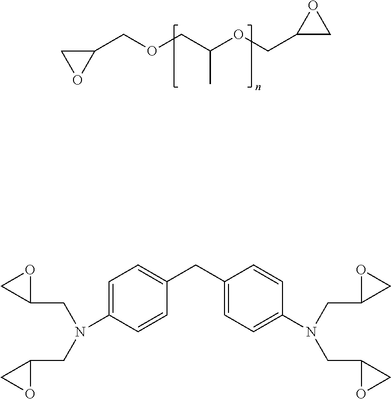

These are examples of liquid materials in side-A (first component) that assist in delaying the fast reaction of the material at the deposition temperature. Using a metal carbonate in side-A (first component) could also slow the reaction by reacting with the acid and/or the acidic derivatives in side-B (second component) to create salts. These metal carbonates may be used when foaming of the resulting material is required, through the release of carbon dioxide as a decomposition product.

Additional components may be selected to optimize the reactivity of the system. Certain components may impact the handling and cure time when they are added to the side-B (second component). Epoxonic 328 (a di-carboxylic acid), many commercially available phosphate esters, and cashew nut shell liquid-based phosphate esters are some examples. These acidic materials and esters react much slower than phenyl glycidyl ether-based phosphate esters, 2-ethylhexyl glycidyl ether-based phosphate esters and phosphoric acid. Using a higher ratio of esters to phosphoric acid could also slow the reaction and increase the handling time, if necessary. These are materials and formulating techniques to utilize in optimizing reactivity if needed. As mentioned, the gel-time or fixture-time might need to be adjusted depending on the manufacturing process of the part.

Another component which may be used in the sprayable thermosetting composition is a bisphenol F epoxy resin with dispersed core-shell particles. This component is a liquid ingredient containing an impact modifier that provides fracture toughness and consistent morphology and offers low viscosity compared to other existing compositions with similar percentage of core/shell particles. Although this material has a relatively high viscosity at ambient temperature (compared to other liquids in the sprayable composition), the viscosity reduces rapidly at elevated temperatures and shear rates. Use of this material in the formulation has multiple benefits. Examples of this component are available under the tradename Kane Ace MX-267. This component does not significantly increase the “liquid viscosity” since it contains 63% low viscosity Bisphenol-F di-epoxide. The important criterion for verifying that a formulation is impingement mixable is the liquid viscosity (i.e., the viscosity of all liquid ingredients absent the presence of particulate matter). The viscosity of the liquid Bisphenol-F resin is 2000-3000 cPs at 25° C. The other 37% of this core-shell product is butadiene-acrylic copolymer particles and therefore part of the particulate matter group.

Unless expressly stated otherwise, the viscosity of the above liquid Bisphenol-F resin is determined according to according to ASTM D2556-14 at 23° C.

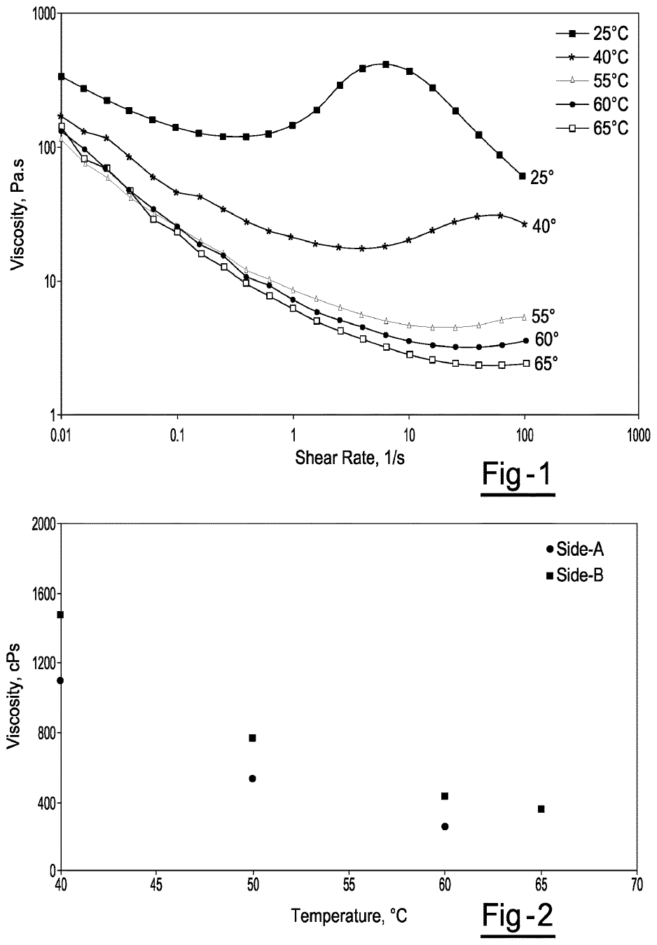

This polymeric particle component (or core shell material) may be a thixotropic shear thinning material. It has a unique behavior at different temperatures and shear rates, having an extreme shear thinning behavior at the deposition temperature. FIG. 1 shows how the viscosity of Kane Ace MX-267 changes at different temperatures and shear rates. This core-shell containing ingredient is very low viscosity at high shears and higher temperatures which are the deposition conditions for these thermosetting sprayable compositions. Therefore, the formulations could benefit from the properties of this core-shell particle incorporation and is not impacted significantly by high viscosity.

The system described herein may also include epoxy phenol novolac resins. Examples of such components can be found under the tradenames Epalloy 8250 or DEN 426 from Olin. This component may be a 2.6 functional resin. This material is a relatively high viscosity fast-curing resin. It is useful to obtain the final properties and also some initial reaction and crosslinking that help in maintaining the 3-dimensional structure of the sprayed material after deposition.

FIG. 2 shows the viscosity of liquid section of side-A (first component) and side-B (second component) of an example formulation. The viscosity of both side-A (first component) and side-B (second component) decreases significantly at higher temperatures. This facilitates impingement mixing and spray application of the material. Measurements shown are at shear rates lower than what would occur during impingement mixing. Measured apparent viscosity will be lower when measured at higher shear rates. Therefore, the viscosity at deposition conditions is expected to be lower than what is shown in FIG. 2.

FIG. 2 shows Brookfield viscosity according to ASTM D2556-14 of liquid sections of side-A (first component) and side-B (second component) of formulation 248B. Brookfield viscosity was measured using spindle LV3 at rates between 20 RPM and 100 RPM. 20 RPM is equal to shear rate of 6.8 S-1 and 100 RPM is equal to 34 S-1.

The A-side (first component, first part) may include di- or multi-functional silicone pre-polymers with epoxide terminal end groups. One non-limiting example is available under the tradename Silmer EPC Di-50 which is a siloxane pre-polymer with cycloaliphatic epoxide groups. Silmer EPC Di-50 is a difunctional reactive polymer which can reduce the elastic modulus in the cured composition. This material is low viscosity (50 to 150 cps at 25° C.) that can significantly reduce the viscosity of the mixed liquid portion of the side A. Another example is Silmer EPC Di-100 which is another linear difunctional epoxide terminated siloxane pre-polymer with viscosity of 150-300 cps at 25° C.

Unless expressly stated otherwise, the viscosity of the above silicone pre-polymers is determined according to ASTM D2556-14 at 23° C.

The A-side (first component) may also include one or a combination of di-functional or multi-functional reactive diluents. Examples of suitable reactive diluents include, but not limited to, those sold under the trade names ERISYS® GE-31, ERISYS® GE-24, and ERISYS® GE-21 commercially available from Huntsman Company. ERISYS® GE-31 is a tri-functional diluent (Trimethylolethane Triglycidyl Ether) with a viscosity of 200-300 cps that could be used to reduce viscosity, increase the crosslink density, and enhance the chemical resistance. ERISYS® GE-21 is an aliphatic di-functional diluent (1,4-Butandiol Diglycidyl Ether) with viscosity of 120-130 cps at 25° C. and can be utilized to reduce the viscosity and improve the flexibility. ERISYS® GE-25 is another aliphatic di-functional diluent (1,6-Hexanediol Diglycidyl Ether) with viscosity of 143-156 cps at 25° C. and can be utilized to reduce the viscosity.

The A-side (first component) may include any combination of mono-functional reactive diluents. Mono-functional reactive diluents can be used to reduce the viscosity and crosslink density of the final product, thereby affecting reaction exotherm and physical properties potentially. Some examples of mono-functional reactive diluents may include but not limited to ERISYS® GE-6, ERISYS® GE-7, ERISYS® GE-8, ERISYS® GE-11, ERISYS® GE-12, and ERISYS® GE-13. ERISYS® GE-6 is 2-Ethylhexyl Glycidyl Ether with viscosity of 1-4 cps at 25° C. ERISYS® GE-7 is a C₈-C₁₀ Aliphatic Glycidyl Ether with viscosity of 1-6 cps at 25° C. ERISYS® GE-8 is a C₁₂-C₁₄ Aliphatic Glycidyl Ether with viscosity of 5-10 cps at 25° C. ERISYS® GE-11 is a p-tertiary Butyl Phenyl Glycidyl Ether with viscosity of 20-30 cps at 25° C. ERISYS® GE-12 is a Nonyl Phenyl Glycidyl Ether with viscosity of 100-140 cps at 25° C. ERISYS® GE-13 is a Phenyl Glycidyl Ether with viscosity of 4-7 cps at 25° C. (all according to ASTM D2556-14 at 23)°.

Unless expressly stated otherwise, the viscosity of the above reactive diluents is determined according to according to ASTM D2556-14 at 23° C.

The B-side (second component, second part) may include one or more commercial phosphate esters. Some non-limiting examples of the commercially available phosphate esters include Butyl Acid Phosphate from Isle Chem Company, with the acid number of 430 mg KOH/g and viscosity of 343 cps at 25° C., Phenyl Acid Phosphate from Isle Chem Company, with the acid number of 273-325 mg KOH/g, Ilco Phos 202 from ILCO Chemikaline Company, with the acid number of 440-490 mg KOH/g, Miramer SC 1400 from MIWON with acid number of 220-350 mgKOH/g and viscosity of 1100 cps at 25° C.

The B-side (second component) may also include a carboxyl terminated butadiene-acrylonitrile (CTBN) copolymer or any other CTBN copolymers. CTBN can improve toughness and reduce acidity in the B-side (second component). Viscosity of Hypro 1300×31 is high (65000 cPs at 27° C.), but only small amounts of it is used. Examples of suitable CTBN copolymers are available under the tradename Hypro 1300×31 from Huntsman Company.

The B-side (second component) may also include difunctional dimer and/or trimer acids. These dimer and trimer acids reduce acidity, improve compatibility, and are stable in the formulated composition of the B-side (second component). They may also improve the flexibility of the final product. Example of suitable dimer and trimer acids are available under the tradenames Prypol 1013 from Croda Company (with an acid number of 196 mgKOH/g) and Pripol 1040 from Croda Company (with an acid number of 189 mgKOH/g).

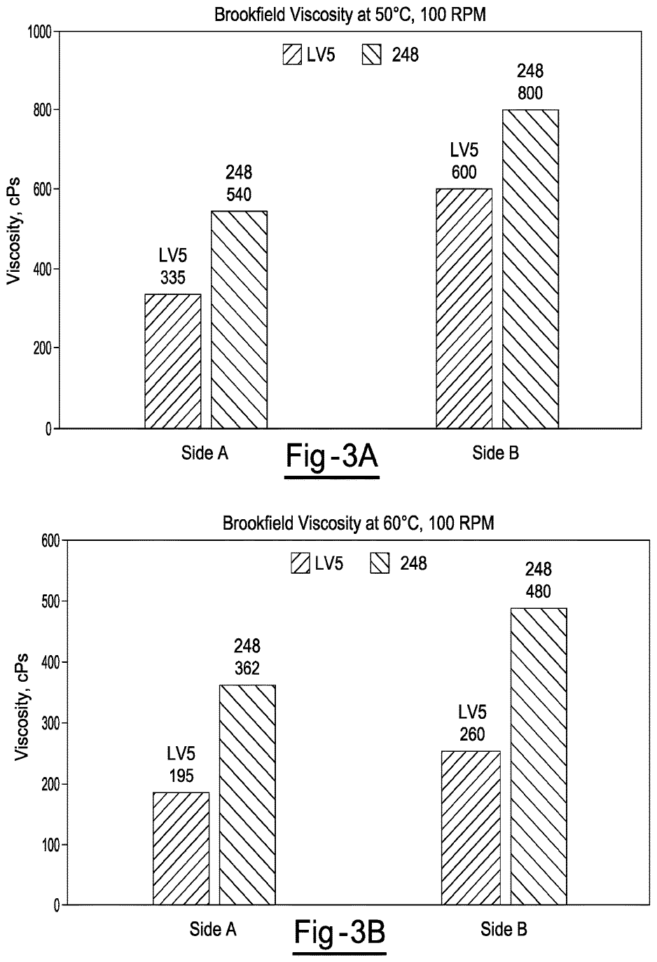

Table 1 shows formulation details for two different sprayable formulations (248 and LV5). FIGS. 3A and 3B compare viscosities of side-A (first component) and side-B (second component) of the two different formulations (Shear rate is 34 S-1). Viscosities (at same temperatures and shear rates) for both side-A (first component) and side-B (second component) of formulation LV5 are much lower than those for formulation 248. Both formulations have a viscosity that is sufficiently low to enable spraying. However, the viscosity of formulation LV5 is approximately 50% lower than viscosity of formulation 248. This example shows that viscosity of a formulation could be reduced as much as 50%, but with comparable or improved properties.

As shown in Table 2, handling time, density and lap shear properties remain unchanged in the two formulations. Tensile strength and elastic modulus increased in the LV5 material having the lower viscosity. In other words, using the formulation techniques above, physical and mechanical properties could be adjusted without changing the specific gravity of the final product or the open time/handling time. It might be difficult to achieve a sufficient strain to failure as viscosity of the formulation decreases. But as shown in Table 2, using these compositions, it is possible to make high elongation and high modulus materials (sample 248).

TABLE 1
Formulation details for two different sprayable formula (248 and LV5)

| | | | | Viscosity cPs at 25° C. |
|---|---|---|---|---|
| | | 248 | LV5 | unless noted |
| A-Side (first component) | | | | |
| Epalloy 8250 | | 51.86 | 38.83 | 18,000-28,000 |
| Epoxidized aniline | | 0.49 | 0.49 | 3,000-6,000 at 50° C. |
| YDF-172 LV | | 0.00 | 12.62 | 2,000-3,000 |
| Kane Ace MX-267 | Bisphenol F | 9.25 | 9.17 | 2,000-3,000 |
| (generic name | Butadiene-acrylic copolymer | 5.43 | 5.39 | — |
| needed) | | | | |

| | | | |
|---|---|---|---|
| KSR 177 | 9.78 | 9.71 | 9,000-15,000 |
| DER 732 | 9.78 | 9.71 | 60-70 |
| Q2 | 0.88 | 1.07 | — |
| Q 200 | 1.76 | 2.33 | — |
| Aerosil R208 | 0.98 | 0.97 | — |
| Vansil HR2000 | 8.81 | 7.28 | — |
| Halox SZP391 | 0.98 | 2.43 | — |
| Total | 100.00 | 100.00 | 20,500 (248) |
| | | | 18,200 (LV5) |
| B-Side (second component) | | | |
| Cashew nut shell liquid -based phosphate ester | 22.12 | 17.09 | 50,000-55,000 |
| 2-ethylhexyl glycidyl ether -based phosphate ester | 26.55 | 47.01 | 3,000-4,000 |
| Phenyl glycidyl ether -based phosphate ester | 30.97 | 12.82 | 12,000-15,000 |
| Vansil HR2000 | 8.85 | 8.55 | — |
| Aerosil R208 | 2.65 | 2.56 | — |
| Epoxonic 328 (di-carboxyl functional modifier) | 1.77 | 0.00 | 7,000 |
| H3PO4 85% | 7.08 | 11.97 | 3-6 |
| Total | 100.00 | 100.00 | 22,000 (248) |

8,700 (LV5)

TABLE 2
Properties of two different sprayable formula (248 and LV5)

| Properties | 248 | LV5 |
|---|---|---|
| Specific Gravity, (g/cc) | 0.68 | 0.67 |
| Open time (min) | 4 | 3 |
| Lap shear at 1 mm Bond-line Al-6022 0.9 mm | 6.8 | 7.2 |
| thick, overlap of 25.4 × 25.4 mm (MPa) | | |
| Tensile strength (MPa) | 4.6 | 11 |
| Tensile Modulus (MPa) | 265 | 870 |
| Elongation % tensile | 10 | 4 |

In addition to some of the ingredients of current teaching being shear thinning, the full formulation may be highly shear thinning as well. This means that the apparent viscosity of the material reduces significantly during the impingement and spray process (deposition) and facilitates the deposition. The material recovers immediately to a higher viscosity when the shear rate is reduced or goes to zero, close to the initial viscosity at low shear rate, shortly after deposition. This allows the user to take advantage of the low viscosity when needed (during the mixing and spraying); and enables the user to apply material thickly without concern for sag or material flow.

FIGS. 3A and 3B show the viscosity of the B-side (second component) (including the non-liquid constituents) of formulation 248, at two different temperatures and different shear rates (all these rates are considered very low compared to those at the deposition condition). The viscosity of both side-A (first component) and side-B (second component) decreases significantly at higher temperatures and higher shear rates.

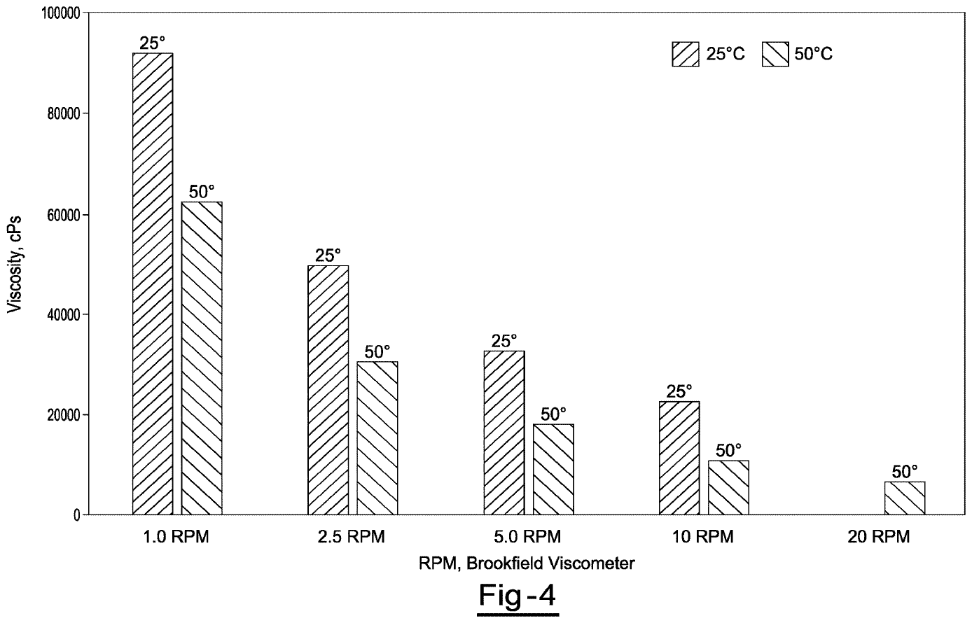

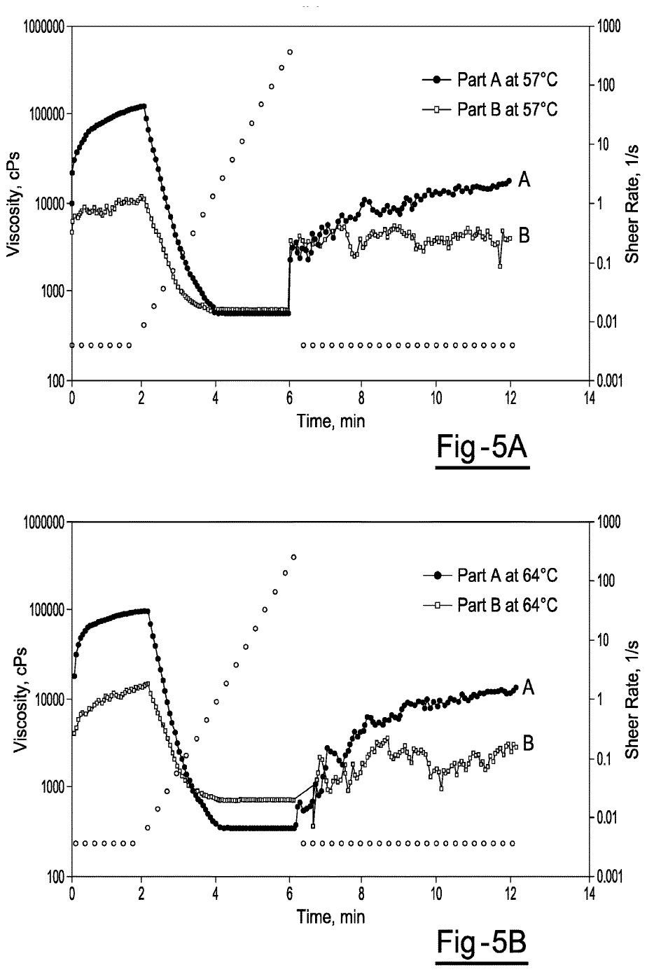

FIG. 4 shows the viscosity of the B-side (second component) (including the non-liquid constituents) of formulation 248 at various RPM rates. FIGS. 5A and 5B show the 3ITT (3 Interval Thixotropy Testing) results that shows viscosity at different shear rates and 2 different temperatures (57° C. and 64° C.). 3ITT is a rheological technique to explore the time-dependent structural recovery of a viscoelastic material. This procedure is typically a shear-rate controlled test, measuring viscosity at a very low shear rate, followed by viscosity measurement at a much higher rate, then a return to the original shear rate. The time spent at each shear rate is material dependent, with the only criterion being that a constant shear viscosity value (or plateau value) can be achieved at each shear rate. Reported results typically compare the initial plateau value to the final value, or the time necessary for the viscosity to return to its original value.

In our specific example, viscosity is measured at a shear rate of 0.004 (1/sec) for 120 seconds, the rate is then logarithmically ramped from 0.004 to 400 (1/sec) over the course of 120 seconds and held at 400 (1/sec) for an additional 120 seconds. The test concludes by immediately reducing the shear rate from 400 to 0.004 (1/sec) and subsequently measuring the viscosity recovery over the next 480 seconds.

Both side-A (first component) and side-B (second component) are at high viscosity at very low shear rate 0.004 (1/sec). Viscosity of both components drop very rapidly as the shear rates increase to 400 (1/sec) and then they recover to close to their initial viscosities as soon as the shear rate is back to 0.004 (1/sec). Being shear thinning and thixotropic at different temperatures is beneficial, especially to reduce the viscosity when needed (only during mixing and deposition) and then to return to higher viscosities to maintain the thickness or shape and reduce the flowability of material (immediately after deposition). These shear rates are generally lower than the shear rates that the material is exposed to during the impingement and spray applications.

Another advantage of the current thermosetting composition is that the formulation does not utilize organic volatiles or other flammable ingredients to produce viscosity reduction. Some critical ingredients in other two-component technologies contain organic volatiles or are flammable at elevated temperatures. For example, in a spray polyurethane foam application, the application area should be restricted to those wearing appropriate personal protective equipment due to inhalation hazards from spray polyurethane (typically isocyanate monomers). The lack of organic volatile ingredients reduces the risk and severity of inhaling material while spraying. There are no toxic materials that prevent spraying. Lack of any organic volatiles and flammable ingredients allow the user to increase the temperature if needed to adjust application viscosity or cure kinetics.

The two-component thermosetting compositions described herein may be relatively insensitive to mix ratio. For example, one target ratio of side-A (first component) to side-B (second component) is 4:1 (v/v). However, small deviations from this ratio may not affect the final properties significantly. Table 3 shows an example where the ratio changes in the range of 3.4:1 to 4.6:1 and illustrates that a significant deviation from the target ratio does not impact the physical properties of the sprayed material. This is considered as another advantage of the thermosetting composition described herein. In case of mix ratio deviations from ratio caused by pressure fluctuation from pumping system in impingement equipment, or other types of malfunctions from static/dynamic mixing equipment, the final properties of the composition may not be impacted significantly.

TABLE 3
Example of ratio change in the range of
3.4:1 to 4.6:1 and impact on properties.

| Mix Ratio (by volume) | 3.4:1 | 3.7:1 | 4:1 | 4.3:1 | 4.6:1 |
|---|---|---|---|---|---|
| Density, g/cc | 0.61 | 0.64 | 0.63 | 0.67 | 0.74 |
| Lap Shear 6061T6 on | 8.58 | 10.54 | 10.75 | 9.89 | 6.33 |
| 2.0 mm Al (1 mm | | | | | |
| bond-line), MPa | | | | | |
| Tensile Modulus, MPa | 754 | 683 | 745 | 712 | 472 |
| Tensile Peak Stress, MPa | 9.6 | 9.4 | 9.4 | 9.2 | 6.5 |
| Tensile Elongation, % | 3.9 | 3.9 | 3.1 | 4.3 | 9.7 |

The present teachings illustrate the feasibility of spray application for a wide range of room-temperature activated systems, including rigid structural foams, cavity filling materials, gaskets, and sealants where phosphoric acid, phosphate esters, and acidic constituents may be used as curatives for an epoxy resin and possibly as foaming agents. Table 4A shows a few different sprayable formulations and Table 4B illustrates their properties. Sprayable, high strength bonding with aluminum and electrocoated (E-coated) aluminum at low densities have been the targets for this study. As shown, all of the compositions maintain good lap shear results and show a range of mechanical properties, from very rigid structural materials to more compliant higher strain to failure compositions.

TABLE 4A

| | 232 W | 236 Z | 248 B | P-100 |
|---|---|---|---|---|
| Side-A (first component) | | | | |
| DER 331 | 4.49 | 0.00 | 0.00 | 0.00 |
| Epalloy 8250 | 17.97 | 51.86 | 51.86 | 51.86 |
| NC-514 | 13.48 | 0.00 | 0.00 | 0.00 |
| Epoxidized aniline | 0.00 | 0.49 | 0.49 | 0.49 |
| GE 60 | 16.17 | 0.00 | 0.00 | 0.00 |
| Polymeric particle in liquid epoxy | 10.78 | 14.68 | 14.68 | 14.68 |
| KSR 177 | 8.98 | 9.78 | 9.78 | 9.78 |
| DER 732 | 13.48 | 9.78 | 9.78 | 9.78 |
| Epoxonic Adduct | 2.70 | 0.00 | 0.00 | 0.00 |
| Q2 | 0.54 | 0.88 | 0.88 | 0.88 |
| Q 200 | 1.08 | 1.76 | 1.76 | 1.76 |
| TS 720 | 1.35 | 0.98 | 0.98 | 0.98 |
| Vansil HR2000 | 8.98 | 9.79 | 8.81 | 8.81 |
| Halox SZP391 | 0.00 | 0.00 | 0.98 | 0.98 |
| Total | 100.00 | 100.00 | 100.00 | 100.00 |
| Side-B (second component) | | | | |
| Cashew nut shell liquid -based | 22.52 | 22.12 | 22.12 | 24.19 |
| phosphate ester | | | | |
| 2-ethylhexyl glycidyl ether -based | 0.00 | 0.00 | 26.55 | 29.02 |
| phosphate ester | | | | |
| Phenyl glycidyl ether -based | 58.56 | 57.52 | 30.97 | 33.86 |
| phosphate ester | | | | |
| Vansil HR2000 | 9.01 | 8.85 | 8.85 | 0.00 |
| TS 720 | 2.70 | 2.66 | 2.65 | 0.00 |
| Garamite G1958 | 0.00 | 0.00 | 0.00 | 1.00 |
| Epoxonic 328 | 0.00 | 1.77 | 1.77 | 1.93 |
| H3PO4 85% | 7.21 | 7.08 | 7.08 | 10.00 |
| Total | 100.00 | 100.00 | 100.00 | 100.00 |

TABLE 4B

| Properties | 232 W | 236 Z | 248 B | P-100 |
|---|---|---|---|---|
| Specific gravity, g/cc | 0.72 | 0.64 | 0.68 | 0.64 |
| Open time at ambient temp, min | 5 | 5 | 4 | 3 |
| Lap shear at 1 mm bond-line, | 7.3 | 6.1 | 6.8 | 7.1 |
| Al-6022 at 0.9 mm thickness, MPa | | | | |
| Lap shear at 1 mm bond-line, | 7.1 | 7.6 | 7.8 | — |
| E-coat Al at 1 mm thickness, MPa | | | | |
| Compressive Modulus, MPa | 85 | 422 | 318 | 430 |
| Tensile strength, MPa | 6 | 3.9 | 10 | 5.9 |
| Tensile Modulus, MPa | 100 | 369 | 265 | 418 |
| Tensile Elongation, % | 30 | 6.9 | 4.6 | 6.2 |

As can be appreciated from the above, sample 232 W shows improved elongation as compared to the other samples, but a reduced tensile and compressive modulus. Sample 248 B has a higher tensile modulus than the remaining samples, but a lower elongation. Sample P-100 has relatively high compressive and tensile modulus and tensile strength but failed in lap shear testing where electro-coat fluid was present. Accordingly, the compositions can be formulated to address the needs of a specific application.

Both side-A (first component) and side-B (second component) of two-component composition described herein may be stable at elevated temperature, which allows a user to incorporate higher viscosity material into the formulated composition and take advantage of the heat for the mixing and spraying process (where the viscosity needs to remain below a threshold at the deposition temperature). Both side-A (first component) and side-B (second component) could be held at elevated temperatures, up to 80° C. or even higher, for extended periods of time (e.g., hours or days) without risk of decomposition or reaction instability.

It is possible that neither the side-A (first component) nor the side-B (second component) are sensitive to moisture. Sprayed material is very thin and has significant air exposure immediately after exiting the spray nozzle and before contacting the substrate. The current two component sprayable composition may therefore not require any special processing adaptation due to its relative moisture insensitivity.

Depending on the type of chemistry utilized, the amount of material in each shot, and/or the viscosity and number of chemical streams, a variety of mix head styles are possible. For example, a straight mix head could be adequate where volumetric mix-ratio is close or at 1:1. However, an L-shaped mix head may be preferable when the ratio is far from 1:1 and/or higher mixing energy is required due to higher viscosity. In other words, the viscosity, at application temperature, and ratio of the two components impact the exact style of equipment required to deliver the two components at high pressure to the mix head. Although impingement mixing works best for very low viscosity compositions, the current material could also be applied using any two-component static or dynamic mixing equipment.

There are impingement systems with proper pumping units capable of providing adequate pressure for impinging adequately highly filled systems (high viscosity materials due to use of solid fillers). Those systems could also maintain the accurate ratio, temperature, and uniform flow. However, to maintain the high quality of mixing and providing uniform stream, the viscosity of the liquid portion of the material could not exceed a specific range.

The A-side (first component) may include one or more additional epoxide functional materials, which may include epoxy resins. The additional epoxy resins may include multifunctional aromatic epoxy resins, multifunctional aliphatic epoxy resins, silane modified epoxy resins, epoxy/elastomer adducts, epoxidized natural products such as soybean oil, or any combination thereof.

The A-side (first component) may include one or more epoxy-based materials (i.e., one or more epoxy resins). The one or more epoxy resins may be any conventional dimeric, oligomeric, or polymeric epoxy resin. The one or more epoxy resins may contain at least one epoxide functional group (i.e., monofunctional) or may contain more than one epoxide functional group (i.e., multifunctional). The one or more epoxy resins may contain one or more epoxide functional group, two or more epoxide functional groups, three or more epoxide functional groups, or even four or more epoxide functional groups. The one or more epoxy resins may be modified epoxy resins (e.g., silane modified, elastomer modified, and the like). The one or more epoxy resins may be aliphatic, cycloaliphatic, aromatic, or the like, or any combination thereof. The one or more epoxy resins may be supplied as a solid (e.g., as pellets, chunks, pieces, or the like, or any combination thereof) or a liquid (e.g., a liquid epoxy resin). As used herein, unless otherwise stated, an epoxy resin is a solid if it is solid at a temperature of 23° C. and is a liquid resin if it a liquid at a temperature of 23° C. The one or more epoxy resins may include one or more liquid epoxy resins, one or more flexible epoxy resins, one or more epoxy phenol novolac resins, one or more aliphatic multifunctional epoxy resins, one or more reactive diluents, one or more phenoxy resins, one or more silane modified epoxy resins, or any combination thereof.

The two-part system may include one or more liquid epoxy resins. The liquid epoxy resin may function as a base for the epoxy resin component. The liquid epoxy resin may be a reaction product of epichlorohydrin (hereinafter, “EPH”) and any conventional bisphenol. The liquid epoxy resin may be a reaction product of EPH and bisphenol A (hereinafter, “BPA”), bisphenol F (hereinafter, “BPF”), or both. The liquid epoxy resin may have an epoxide equivalent weight (hereinafter “EEW”) from about 160 g/equivalent to about 192 g/equivalent as measured according to ASTM D1652-97. The liquid epoxy resin may have an epoxide percentage from about 20 to about 25. The liquid epoxy resin may have a viscosity from about 2,000 cP to about 14,000 cP at 25° C. as measured according to ASTM D445. An example of a suitable BPA-based liquid epoxy resin may be D.E.R.™ 331, commercially available from The Olin Corporation (Clayton, MO). An example of a suitable BPF-based liquid epoxy resin may be YDF-170 commercially available from Kukdo Chemical (South Korea).

The liquid epoxy resin may be present as a part of the A-side (first component). The liquid epoxy resin may be present in an amount of from about 4% to about 70% by weight of the A-side (first component). The liquid epoxy resin may be present in an amount of from about 6% to about 10% by weight of the A-side (first component). The liquid epoxy resin may be present in an amount of about 8% by weight of the A-side (first component).

The two-part system may include one or more flexible epoxy resins. The one or more flexible epoxy resins may function to reduce the compression modulus, increase strain to failure, decrease time to recover, decrease the degree of cross-linking density, increase impact resistance, improve adhesion, improve peel resistance, or any combination thereof, of the reaction product. The one or more flexible epoxy resins may improve the gas entrapment capability of the two-part system impart by acting as a viscosity modifier. The one or more flexible epoxy resin may be a di-functional glycidyl ether epoxy resin, an unmodified BPA-based epoxy resin, a multifunctional epoxidized polybutadiene resin, or any combination thereof. The one or more flexible epoxy resins may have an EEW of about 260 to about 500 as measured according to ASTM D1652-97. The one or more flexible epoxy resins may have a viscosity of about 700 cP to about 25,000 cP at 25° C. as measured according to ASTM D445. Examples of suitable flexible epoxy resins may include NC-514 (commercially available from Cardolite Corporation, Monmouth Junction NJ), Araldite® PY 4122 (commercially available from Huntsman Advanced Materials, Inc., Salt Lake City, UT), Poly bd® 605E (commercially available from Cray Valley, Exton, PA), or any combination thereof.

The one or more flexible epoxy resins may be present in the A-side (first component). The one or more flexible epoxy resins may be present in an amount from about 0.5% to about 40% by weight of the A-side (first component). The one or more flexible epoxy resins may be present in an amount from about 35% to about 45% by weight of the A-side (first component). The one or more flexible epoxy resins may be present in an amount of about 39% by weight of the A-side (first component). The one or more flexible epoxy resins may include a di-functional glycidyl ether epoxy resin in the amount of from about 10% to about 18% by weight of the A-side (first component), an unmodified BPA-based epoxy resin in an amount from about 8% to about 16% by weight of the A-side (first component), and a multifunctional epoxidized polybutadiene resin in an amount from about 8% to about 16% by weight of the A-side (first component). The one or more flexible epoxy resins may include a di-functional glycidyl ether epoxy resin in the amount of about 5% to 20% by weight of the A-side (first component), an unmodified BPA-based epoxy resin in an amount of about 5% to about 20% by weight of the A-side (first component), and a multifunctional epoxidized polybutadiene resin in an amount of about 5% to about 20% by weight of the A-side (first component). The two-component system may include a di-functional glycidyl ether epoxy resin, a difunctional epoxy derived from cardanol, and a multifunctional epoxidized polybutadiene resin, respectfully in a ratio of about 1:1:1. The two-component system may include a di-functional glycidyl ether epoxy resin, a difunctional epoxy derived from cardanol, and a multifunctional epoxidized polybutadiene resin. The aforementioned resins may be present in a ratio of about 1:0.8:0.8, respectively. The two-component system may include a di-functional glycidyl ether epoxy resin, a difunctional epoxy derived from cardanol, and a multifunctional epoxidized polybutadiene resin. The aforementioned resins may be present in a ratio of about 1:0.9:0.9, respectfully.

The two-part system described herein may also include one or more epoxy phenol novolac resins. The one or more epoxy phenol novolac resins may function to impart chemical resistance, solvent resistance, temperature resistance, or any combination thereof, to the reaction product. The one or more epoxy phenol novolac resins may be present as a part of the A-side (first component). The one or more epoxy phenol novolac resins may have an EEW from about 165 g/equivalent to about 183 g/equivalent as measured according to ASTM D1652-97. The one or more epoxy phenol novolac resins may have an average epoxy functionality from about 2.1 to about 6.5. The one or more epoxy phenol novolac resins may have a viscosity from about 18,000 cP to about 30,000 cP at 25° C. as measured according to ASTM D445. Examples of suitable epoxy phenol novolac resins may be those sold under the trade names Epalloy® 8250 (formaldehyde, oligomeric reaction products with 1-chloro-2,3-epoxypropane and phenol; 2.6 functionality) and Epalloy® 8330 (Poly [(phenyl glycidyl ether)-co-formaldehyde]; 3.6 functionality), commercially available from CVC Thermoset Specialties (Moorestown, NJ).

The one or more epoxy phenol novolac resin may be present in an amount from about 10% to about 60% by weight of the A-side (first component). The one or more epoxy phenol novolac resins may be present in an amount of about 35% to about 45% by weight of the first component or A-side (first component). The one or more epoxy phenol novolac resins may be present in an amount of about 38% to about 42% by weight of the A-side (first component). The one or more epoxy phenol novolac resins may be present in an amount of about 42% by weight of the A-side (first component). The one or more epoxy phenol novolac resins may include an about 3.6 functional epoxy phenol novolac resin present in an amount of from about 0.1% to about 50% by weight of the A-side (first component) and an about 6.5 functional epoxy novolac resin present in an amount of from about 22% to about 32% by weight of the A-side (first component). The one or more epoxy phenol novolac resins may include an about 3.6 functional epoxy phenol novolac resin present in an amount of about 15% by weight of the A-side (first component) and an about 6.5 functional epoxy novolac resin present in an amount of about 28% by weight of the A-side (first component). The two-part system may include an about 3.6 functional epoxy phenol novolac resin and an about 6.5 functional epoxy phenol novolac resin at a ratio of about 1:2 to about 1:3.

The two-part system may include one or more aliphatic multifunctional epoxy resins. The one or more aliphatic multifunctional epoxy resins may function to increase the degree of cross-linking of the reaction product, increase the chemical resistance of the reaction product, or both. The one or more aliphatic multifunctional epoxy resins may include an epoxidized sorbitol. The one or more aliphatic multifunctional epoxy resins may have an EEW from about 160 g/equivalent to about 195 g/equivalent as measured according to ASTM D1652-97. The one or more aliphatic multifunctional epoxy resins may have a viscosity from about 4,000 cP to about 18,000 cP at 25° C. as measured according to ASTM D445. Examples of suitable aliphatic multifunctional epoxy resins may be those sold under the trade names ERISYS® GE-60 and ERISYS® GE-61, commercially available from CVC Thermoset Specialties (Moorestown, NJ).

The one or more aliphatic multifunctional epoxy resins may be present as a part of the A-side (first component). The one or more aliphatic multifunctional epoxy resins may be present in an amount from about 4% to about 60% by weight of the A-side (first component). The one or more aliphatic multifunctional epoxy resins may be present in an amount from about 10% to about 22% by weight of the A-side. The one or more aliphatic multifunctional epoxy resins may be present in an amount of about 20% by weight of the A-side (first component). The one or more aliphatic multifunctional epoxy resins may be present in an amount of about 13% by weight of the A-side (first component).

The two-part system may include one or more reactive diluents. The one or more reactive diluents may function to reduce the overall viscosity of the two-part system, in order to modify the dispensing process or the flow of the two-part system on a workpiece after dispensing, increase the degree of cross-linking of the reaction product, for multi-functional diluents or both. The one or more reactive diluents may be polymeric, whereby the reactive diluent may increase the flexibility of the reaction product; the one or more reactive diluents may be multifunctional, whereby the reactive diluent may promote increased crosslinking and impart chemical resistance on the reaction product; or both. The one or more reactive diluents may include a polyglycol diglycidyl ether, a trimethylolethane triglycidyl either, or both. The one or more reactive diluents may have an EEW from about 150 g/equivalent to about 170 g/equivalent as measured according to ASTM D1652-97. The one or more reactive diluents may have a viscosity of about 200 cP to about 300 cP at 25° C. as measured according to ASTM D445. An example of a suitable reactive diluents may be those sold under the trade names ERISYS® GE-31 and ERISYS® GE-24, commercially available from CVC Thermoset Specialties (Moorestown, NJ).

The one or more reactive diluents may be present in an amount from about 5% to about 20% by weight of the A-side (first component). The one or more reactive diluents may be present in an amount from about 8% to about 16% by weight of the A-side (first component). The one or more reactive diluents may be present in an amount from about 10% to about 14% by weight of the A-side (first component). The one or more reactive diluents may be present in an amount of about 13% by weight of the A-side (first component). The one or more reactive diluents may include a polyglycol diglycidyl ether present in an amount from about 2% to about 6% by weight of the A-side (first component), and a trimethylolethane triglycidyl present in an amount from about 6% to about 14% of the A-side (first component). The one or more reactive diluents may include a polyglycol diglycidyl ether present in an amount of about 4% by weight of the A-side (first component), and a trimethylolethane triglycidyl present in an amount of about 9% of the A-side (first component). The two-part system may include a polyglycol diglycidyl ether and a trimethylolethane triglycidyl ether respectively at a ratio of about 1:2 to about 1:3.

The two-part system may include one or more silane modified epoxy resins. The one or more silane modified epoxy resins may function to impart improved adhesion to the reaction product, particularly adhesion to glass, metals, or both. An example of a suitable silane modified epoxy resin may be that sold under the trade name EPOKUKDO® KSR-177 commercially available from Kukdo Chemical (South Korea). The silane modified epoxy may be a linear-difunctional silicone pre-polymer terminated with a cyclic epoxide (e.g., a pre-polymer with cycloaliphatic epoxide group). Another suitable material would be a silicone pre-polymer with cycloaliphatic epoxide groups. An example of one such material is available under the trade name Silmer EPC Di-50, available from Siltech Corporation in Ontario, Canada.

The one or more silane modified epoxy resins may be present in the A-side (first component). The one or more silane modified epoxy resins may be present in an amount of about 1% to about 7% by weight of the A-side (first component). The one or more silane modified epoxy resins may be present in an amount of about 2% to about 6% by weight of the A-side (first component). The one or more silane modified epoxy resins may be present in an amount of about 4% by weight of the A-side (first component).

The two-part system may include one or more toughening agents. The one or more toughening agents may function to distribute energy within the reaction product (i.e., increase impact resistance). The one or more toughening agents may contribute to an increased T-Peel strength. The one or more toughening agents may comprise thermoplastics, thermosets or thermosettables, elastomers, the like, or any combination thereof. The one or more toughening agents may include elastomers (including elastomer containing materials), core-shell polymers (which may include but are not limited to elastomers), or both.

The core-shell polymers, if present, may comprise a first polymeric material (i.e., core material) and a second polymeric material (i.e., shell material). The first polymeric material may be entirely encapsulated by the second polymeric material. The core-shell polymer may include a first polymeric material in the amount of about 30% or more, 50% or more, or even 70% or more by weight. The first polymeric material, the second polymeric material, or both may comprise one, two, three, or even more than three polymers that are combined together, reacted together (e.g., sequentially polymerized), or both, or may be part of separate or the same core-shell polymer systems. An example of a suitable core-shell polymer may be that sold under the trade name Kane Ace® MX-267 and MX-257 commercially available from Kaneka North America LLC (Pasadena, TX).

The core-shell polymers may be present in an amount from about 1% to about 25% by weight of the A-side (first component), B-side (second component), or both the A-side (first component) and B-side (second component) in combination (e.g., if present in the amount of 10% by weight, then it may be present in an amount of 5% in the A-side (first component) and 5% in the B-side (second component)). The core-shell polymer may be present in an amount from about 5% to about 20% by weight of the A-side (first component), B-side (second component), or both the A-side (first component) and B-side (second component) in combination. The core-shell polymer may be present in an amount of about 5% by weight of the A-side (first component), B-side (second component), or both the A-side (first component) and B-side (second component) in combination. The core-shell polymer may be present in an amount of about 17% by weight of the A-side (first component), B-side (second component), or both the A-side (first component) and B-side (second component) in combination.

Where the two-part system includes metal carbonate in the A-side (first component), average functionality of the B-side (second component) may be partially reduced when combined with the A-side (first component) in the mixed composition. This may be due to reaction of the acid of the B-side (second component) with the metal carbonates of the A-side (first component) to cause foaming. The A-side (first component) may include components with increased functionality to compensate for a reduced functionality of the B-side (second component). The A-side (first component) may be formulated with increased functionality by using reactive ingredients with functionality higher than 2 such as aliphatic multifunctional epoxy resins.

The B-side (second component) may comprise one or more acids. The acid may be liquid at room temperature. Room temperature, as referred to herein, may mean a temperature of between about 20° C. and 25° C. The acid may have a pH of less than 7. The acid may comprise phosphate ester, phosphoric acid, citric acid, acetic acid, or any acid that is stable when mixed with phosphoric acid or phosphate esters. The acid may comprise at least phosphate ester and optionally phosphoric acid, citric acid, acetic acid, or any combination thereof.

The working time of the mixed composition may be tuned by the selection of the acid. Employing phosphate esters instead of phosphoric acid may delay the curing reaction, due to their higher pH, lower functionality, higher viscosity, or any combination thereof. The functionality and pH of phosphate esters may be selected to tune the working time.

The B-side (second component) may comprise one or more phosphate esters, phosphate ester precursors, or both. The one or more phosphate esters may be pre-reacted. The B-side (second component) may comprise one or more phosphate ester precursors that may be combined with phosphoric acid prior to combination with the A-side (first component).

The B-side (second component) may include additional phosphoric acid. The additional phosphoric acid may include ortho-phosphoric acid, polyphosphoric acid, or both. The additional phosphoric acid may increase the crosslink density and shorten the reaction time. Reaction speed of the pre-reacted phosphate esters may be increased by the addition of the additional phosphoric acid in the B-side (second component). The additional phosphoric acid may increase foaming of the mixed composition.

The one or more phosphate esters may be one or more customized phosphate esters. The one or more customized phosphate esters may be produced by the reaction of phosphoric acid and various alcohols. The one or more customized phosphate esters may be produced by the reaction of phosphoric acid and an epoxide group of a phosphate ester precursor (i.e., component not yet reacted with phosphoric acid). The one or more customized phosphate esters may be produced by the reaction of phosphoric acid with the glycidyl ether of cashew nutshell liquid (CNSL) such as that sold under the trade name Cardolite® LITE 2513HP, commercially available from Cardolite Corporation, Monmouth Junction NJ. The one or more customized phosphate esters may be produced by the reaction of phosphoric acid with a phenyl glycidyl ether such as that sold under the trade name ERISYS® GE-13, commercially available from CVC Thermoset Specialties, Moorestown, NJ. The one or more customized phosphate esters may be produced by the reaction of phosphoric acid with 2-ethylhexyl glycidyl ether such as that sold under the trade name ERISYS® GE-6, commercially available from CVC Thermoset Specialties, Moorestown, NJ. The one or more customized phosphate esters may be produced by the reaction of phosphoric acid with an epoxidized para-tertiary butyl phenol such as that sold under the trade name ERISYS® GE-11, commercially available from CVC Thermoset Specialties, Moorestown, NJ.

The one or more phosphate esters may be one or more commercially pre-reacted phosphate esters. The one or more commercially pre-reacted phosphate esters, when swapped into the B-side (second component) in place of a customized phosphate ester may result in a curable composition that is slower reacting and foaming presumably due to a lower amount of free phosphoric acid. Reacting and foaming of the one or more commercially pre-reacted phosphate esters may be improved (i.e., sped up) by the addition of phosphoric acid in the B-side (second component). The one or more commercially pre-reacted phosphate esters may have a pH of about 1 to 3 in aqueous solution. The one or more commercially pre-reacted phosphate esters may have a viscosity of about 32,500 cP to about 42,500 cP at 25° C. as measured according to ASTM D445. The one or more commercially pre-reacted phosphate esters may be a nonyl phenol ethoxylated phosphate ester. Examples of suitable commercially pre-reacted phosphate esters may be those sold under the trade names of Dextrol™ OC-110, Dextrol OC-40, and Strodex MO-100 commercially available from Ashland, Inc. (Covington, KY).

The commercially pre-reacted phosphate esters may be present in the B-side (second component). The one or more commercially pre-reacted phosphate esters may be present in an amount of about 6% to about 18% by weight of the B-side (second component). The one or more commercially pre-reacted phosphate esters may be present in an amount of about 8% to about 16% by weight of the B-side (second component). The one or more commercially pre-reacted phosphate esters may be present in an amount of about 10% to about 14% by weight of the B-side (second component). The one or more commercially pre-reacted phosphate esters may be present in an amount of about 12% by weight of the B-side (second component).

The one or more phosphate esters may be produced by a reaction of a range of stoichiometric ratios of phosphate ester precursors to phosphoric acid. The one or more phosphate esters may be produced by a reaction of about 0.7:1 phosphate ester precursor to phosphoric acid to about 1:0.7 phosphate ester precursor to phosphoric acid. The one or more phosphate esters may be produced by a reaction of about 0.8:1 phosphate ester precursor to phosphoric acid to about 1:0.8 phosphate ester precursor to phosphoric acid. The one or more phosphate esters may be produced by a reaction of about 0.9:1 phosphate ester precursor to phosphoric acid to about 1:0.9 phosphate ester precursor to phosphoric acid. The one or more phosphate esters may be produced by a reaction of about 1:1 phosphate ester precursor to phosphoric acid. The one or more phosphate esters may be produced by a reaction of about 0.8:1 phosphate ester precursor to phosphoric acid.

The one or more phosphate esters may be selected from mono-esters, di-esters, or tri-esters as shown below:

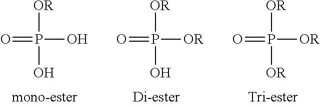

The one or more phosphate esters may be obtained from the reaction of epoxide groups with phosphoric acid as depicted below:

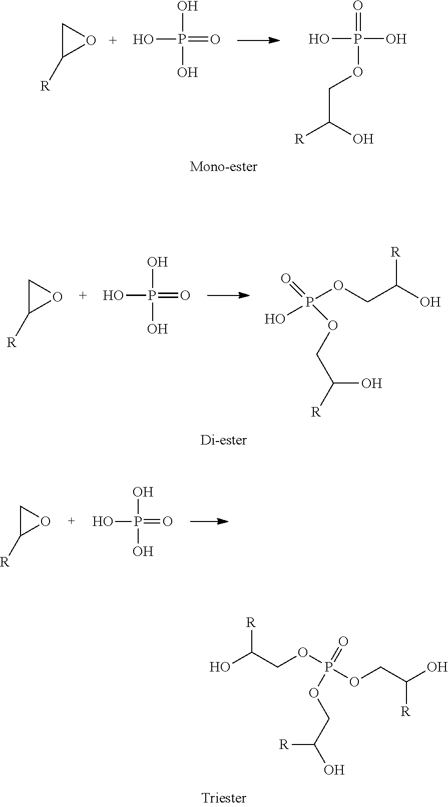

The B-side (second component) may comprise one or more phosphate esters, one or more phosphate ester precursors, or both. The B-side (second component) may comprise one or more phosphate ester precursors that may be combined with phosphoric acid prior to combination with the A-side (first component). The B-side (second component) may comprise one or more phosphate esters that are pre-reacted (i.e., the epoxide and phosphate reaction) before addition to the B-side (second component).

The first phosphate ester may be a reaction product of phosphoric acid with 2-ethylhexyl glycidyl ether. The second phosphate ester may be a reaction product of an epoxidized para-tertiary butyl phenol, a reaction product of a glycidyl ether of cashew nutshell liquid (CNSL), a nonyl phenol ethoxylated phosphate ester, or a combination thereof. The third phosphate ester may be a reaction product of phosphoric acid with a phenyl glycidyl ether. The B-side (second component) may include the first phosphate ester, the second phosphate ester, the third phosphate ester, or a combination thereof.

The first phosphate ester may be present in an amount from about 1% to about 70% by weight of the B-side (second component). The first phosphate ester may be present in an amount from about 5% to about 60% by weight of the B-side (second component). The first phosphate ester may be present in an amount from about 10% to about 30% by weight of the B-side (second component). The second phosphate ester, if present, may be present in an amount from about 1% to about 80% by weight of the B-side (second component). The second phosphate ester may be present in an amount from about 3% to about 50% by weight of the B-side (second component). The second phosphate ester may be present in an amount from about 5% to about 40% by weight of the B-side (second component). The third phosphate ester, if present, may be present in an amount from about 0.5% to about 90% by weight of the B-side (second component). The third phosphate ester may be present in an amount from about 10% to about 70% by weight of the B-side (second component). The third phosphate ester may be present in an amount of about 20% to about 65% by weight of the B-side (second component).

The B-side (second component) may include phosphoric acid. The phosphoric acid may be ortho-phosphoric acid, polyphosphoric acid, or both. The phosphoric acid may be polyphosphoric acid. The phosphoric acid may be free acid in the one or more phosphate esters, added independently from the one or more phosphate esters, or both. The addition of phosphoric acid to the B-side (second component) may result in increased expansion (e.g., foaming) of the resulting reaction product. The addition of phosphoric acid to the B-side (second component) may increase the reactivity of the two-part system to help maintain desired levels of expansion, curing, or both when temperatures are below 23° C.

The independently added phosphoric acid, if present, may be in aqueous solution in the amount of 85% or more, or even 95% or more (i.e., “reagent grade”). The independently added phosphoric acid may be present in an amount from about 0.1% to about 30% by weight of the B-side (second component). The independently added phosphoric acid may be present in an amount from about 2% to about 6% by weight of the B-side (second component). The independently added phosphoric acid may be present in an amount of about 4% by weight of the B-side (second component).

The one or more phosphate esters produced from the reaction of phosphoric acid and one or more epoxide group containing components, may include free acid. The one or more phosphate esters may have about 1% or more free acid, about 3% or more free acid, about 5% or more free acid, about 15% or less free acid, about 13% or less free acid, or even about 11% or less free acid.

The two-component system, upon addition of the A-side (first component) and the B-side (second component), may foam as a result of a reaction of metal carbonate or metal bicarbonate and an acid, generating the release of gas (e.g., carbon dioxide) to serve as chemical blowing agent. Such a reaction mechanism is described in U.S. Pat. No. 5,648,401, incorporated by reference herein for all purposes.

The curing, foaming, or both may occur at a temperature of about 50° C. or less, 40° C. or less, about 30° C. or less, about 20° C. or less, or about 0° C. or less. The curing, foaming, or both may occur at a temperature of about 0° C. or more, about 10° C. or more, or even about 20° C. or more. The curing, foaming, or both may occur at a temperature from about 10° C. to about 50° C., or even more. The curing, foaming, or both may occur at a temperature of about 10° C. The curing, foaming, or both may occur at room temperature (e.g., at a temperature of about 15° C. to about 25° C.). The curing, foaming, or both may occur at a temperature of about 23° C. The curing and foaming may occur at different temperatures or at substantially the same temperature. As previously stated, the system described herein may be free of any foaming. The system described herein may include only minimal foaming (e.g., 0.5% to about 2% volumetric expansion).

Foaming, if present, may begin before complete cure of the resulting reaction product. The foaming time (i.e., the time frame within which the two-part system actively foams) of the reaction product may be 30 minutes or less or even 20 minutes or less. The foaming time of the reaction product may be from about 1 minute to about 10 minutes. The foaming time of the reaction product may be about 5 minutes. The foaming time of the reaction product may be about 7 minutes.

The two-part system may include one or more additives. The one or more additives may include one or more toughening agents, calcium carbonate, minerals, reinforcing fibers or other reinforcing particulates, hydrophobic silica, tabular alumina, or any combination thereof.

The two-part system may include one or more minerals. The one or more minerals (i.e., “mineral reinforcement”) may function to structurally reinforce the reaction product. The one or more minerals may improve tensile strength, the flexural strength, or both of the reaction product. The one or more minerals may be any suitable silicate minerals including but not limited to inosilicates (e.g., Wollastonite) and phyllosilicates (e.g., Kaolinite, Vermiculite, Talc, Muscovite, etc.). The characteristic external shape of an individual crystal or crystal group of the one or more minerals may be acicular or needle-like. The median particle size of the one or more minerals may be from about 10 microns to about 20 microns. The median particle size may be from about 12 microns to about 18 microns.

The one or more minerals may include Wollastonite (CaSiO₃). The Wollastonite may be relatively pure (i.e., less than 2% by weight of impurities such as other metal oxides). The Wollastonite may contain impurities including one or more oxides of iron, magnesium, manganese, aluminum, potassium, sodium, or strontium substituting for calcium in the mineral structure. Examples of suitable Wollastonite may be that sold under the trade names NYGLOS® 12 and NYGLOS® 8 commercially available from NYCO Minerals Inc. (Willsboro, NY).

The one or more minerals may be present as part of the A-side (first component), the B-side (second component), or both. The Wollastonite may be present in an amount from about 1% to about 18% by weight of the A-side (first component), B-side (second component), or both the A-side (first component) and B-side (second component) in combination. The Wollastonite may be present in an amount from about 3% to about 7% by weight of the A-side (first component), B-side (second component), or both the A-side (first component) and B-side (second component) in combination. The Wollastonite may be present in an amount of about 4% by weight of the A-side (first component), B-side (second component), or both the A-side (first component) and B-side in combination.

The reinforcing fiber may be present in the amount from about 0.01% by weight to about 15% by weight of the A-side (first component), B-side (second component), or both the A-side (first component) and B-side (second component) in combination. The reinforcing fiber may be present in the amount from about 1% by weight to about 10% by weight A-side (first component), B-side (second component), or both the A-side (first component) and B-side (second component) in combination. The reinforcing fiber may be present in the amount of about 3% by weight A-side (first component), B-side (second component), or both the A-side (first component) and B-side (second component) in combination.

The two-part system may include hydrophobic silica. The hydrophobic silica may function to control viscosity (e.g., thicken), control thixotropy, boost hydrophobia, or a combination thereof. The hydrophobic silica may be fumed silica. The hydrophobic silica may be surface treated. For example, the hydrophobic silica may be fumed silica surface-treated with polydimethylsiloxane (hereinafter “PDMS”) or hexamethyldisilazane (hereinafter “HMDZ”). The hydrophobic silica may be present as part of the A-side (first component), the B-side (second component), or both. Examples of suitable hydrophobic silica may be that sold under the trade name AEROSIL® R 202 commercially available from Evonik Corporation (Parsippany, NJ); and those sold under the trade name CAB-O-SIL® TS-530 and TS-720 commercially available from Cabot Corporation (Boston, MA).

The hydrophobic silica may be present in an amount of about 0.25% to about 15% by weight of the A-side (first component), B-side (second component), or both the A-side (first component) and B-side (second component) in combination. The hydrophobic silica may be present in an amount of about 0.1% to about 4% by weight of the A-side (first component), B-side (second component), or both the A-side (first component) and B-side (second component) in combination. The hydrophobic silica may be present in an amount from about 1% to about 3% by weight of the A-side (first component), B-side (second component), or both the A-side (first component) and B-side (second component) in combination. The hydrophobic silica may be present in an amount from about 1% by weight of the A-side (first component). The hydrophobic silica may be present in an amount from about 1% to about 3% by weight of the B-side (second component). The ratio of hydrophobic silica in the A-side (first component) to the B-side (second component) may be from about 1:3 to about 3:1. The ratio of hydrophobic silica in the A-side (first component) to the B-side (second component) may be about 1:2 to about 2:1.

The two-part system may be free of curing agents (i.e., typical curing agents), curing accelerators, or both. Typical curing agents include lewis bases (i.e., anionic catalysts), lewis acids (i.e., cationic catalysts), UV catalysts, amines, anhydrides, phenols, thiols, or any combination thereof. In place of the aforementioned curing agents, the two-part system may cure upon a polymerization reaction, catalyzed by phosphoric acid, between phosphate esters and epoxide groups, hydroxy groups, or both. The two-part system may be both cured and caused to expand by the chemical interaction between phosphate ester and calcium carbonate. It has been found that utilizing the cure and expansion system of the present disclosure may reduce the complexity of formulations by reducing the number of overall components (i.e., curing agents, curing accelerators, and blowing agents); however, the achievement of a desired expansion and time to cure is made more challenging to optimize.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. (canceled)

2. A two-part system (two-component system) comprising:
a) a first component comprising
one or more epoxy resins; and
an epoxy functional compound having an epoxy functionality of greater than 4 and a viscosity of 500 mPa·s or less in its neat state;
b) a second component comprising one or more phosphate esters each having a viscosity of 500 mPa·s or less in its neat state;
wherein in each case viscosity is determined as described herein.

3. A two-part system (two-component system) comprising:
a) a first component essentially consisting of
one or more epoxy resins;
an epoxy functional compound having an epoxy functionality of greater than 4; and
optionally, one or more non-liquid constituents;
wherein the one or more epoxy resins and the epoxy functional compound have an overall viscosity of 500 mPa·s (in admixture with one another but in the absence of the one or more non-liquid constituents);
b) a second component essentially consisting of
one or more phosphate esters and
optionally, one or more non-liquid constituents;
wherein the one or more phosphate esters have an overall viscosity of 500 mPa·s or less (in admixture with one another but in the absence of the one or more non-liquid constituents);
wherein in each case viscosity is determined as described herein.

4. The two-part system of claim 3, wherein upon mixing the first component and second component, a resulting composition cures at a temperature of about 0° C. to about 50° C.

5. The two-part system of claim 2, wherein the first component includes an epoxidized di-aniline.

6.-7. (canceled)

8. The two-part system of claim 2, wherein the one or more phosphate esters includes a phosphate ester derived from phenyl glycidyl ether.

9. The two-part system of claim 2, wherein the one or more phosphate esters includes a phosphate ester derived from an epoxidized para-tertiary butyl phenol.

10. (canceled)

11. The two-part system of claim 2, including calcium carbonate present in an amount from about 0.01% to about 10% by weight, relative to the total weight of the two-part system.

12. The two-part system of claim 11, including an ultrafine calcium carbonate (about 1 micron average particle size), a fine calcium carbonate (about 4 micron average particle size), a medium fine calcium carbonate (about 22 micron average particle size), or any combination thereof.

13. The two-part system of claim 3, wherein one or both of the first and second component includes Wollastonite.

14. The two-part system of claim 13, wherein one or both of the first and second component include fumed silica.

15. The two-part system of claim 3, wherein the one or more epoxy resins or epoxy functional material include one or more liquid epoxy resins, one or more epoxy phenol novolac resins, one or more aliphatic multifunctional epoxy resins, one or more phenoxy resins, one or more silane modified epoxy resins, or any combination thereof.

16. The two-part system of claim 2, including one or more epoxy phenol novolac resins with an epoxy functionality from about 2 to about 3; an epoxy phenol novolac resin with an epoxy functionality from about 3 to about 4; or both.

17. The two-part system of claim 3, including one or more epoxy phenol novolac resins present in an amount from about 15% to about 70% by weight, relative to the total weight of first component.

18. The two-part system of claim 3, wherein the two-part system is substantially free of curing agents, latent curing accelerators, or both, other than the one or more phosphate esters.

19. The two-part system of claim 2, wherein the first component, the second component, or both include a dicarboxylic acid-based constituent.

20. The two-part system of claim 2, wherein the first component is substantially free of any epoxy resins that in their neat state are solid at temperatures of 20° C. to 25° C.

21. The two-part system of claim 2, wherein the first component and second component are present in a ratio of from about 5 parts by volume first component:1 part by volume second component to about 1 part by volume first component:1 part by volume second component.

22. The two-part system of claim 3, wherein the second component is substantially free of any epoxy resins that in their neat state are solid at temperatures of 20° C. to 25° C.

23. The two-part system of claim 3, wherein the second component includes less than 5% by weight epoxy resins that in their neat state are solid at temperatures of 20° C.-25° C., relative to the total weight of the second component.

24. The two-part system of claim 2, wherein in each case viscosity is measured at a shear rate of 0.004 (1/sec) for 120 seconds, the rate is then logarithmically ramped from 0.004 to 400 (1/sec) over the course of 120 seconds and held at 400 (1/sec) for an additional 120 seconds; wherein test concludes by immediately reducing the shear rate from 400 to 0.004 (1/sec) and subsequently measuring the viscosity recovery over the next 480 seconds.

25.-26. (canceled)
